(19) United States
(12) Patent Application Publication
(10) Pub. No.: US 2007/0091370 A1
(43) Pub. Date: Apr. 26, 2007

(54) Image forming device

(76) Inventor: Yasushi Saito, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,082

(22) Filed: Oct. 26, 2005

(51) Int. Cl. G06K 15/00

(52) U.S. Cl. 358/1.18

(57) ABSTRACT

The present invention comprises a combined image generating unit 24 which reduces each document images and generates a combined image, so that multiple document images captured by a document image capturing unit 11 fit on a single sheet of printing paper in accord with the type of combined printing selected by a user via an operation unit 13; a printing control unit 25 which extracts marginal regions demarcating document images from the combined image, combines the combined image and advertisement image so that the advertisement image is displayed lengthwise to the marginal region, and generates an output image; and a printing unit 15 which prints the output image on printing paper.

### FIELD OF THE INVENTION

The present invention relates to an image forming device for providing a combined printing function for combining and printing multiple document images on a single sheet of printing paper.

### BACKGROUND INFORMATION

In recent years, copiers have been become known which reduce each document image, generate a combined image, and print borderlines for demarcating each document image in the marginal regions of the combined image, so as to print multiple document images on a single sheet of printing paper.

Also, in recent years, convenience stores and the like have begun to offer copying services with advertisements, in which predetermined advertisement images are added to and printed on the printing paper and the copying fees are discounted. Accordingly, there are various technologies relating to copying services with advertisements. As one technology, an invention is disclosed wherein the advertisement image is printed on the back of the printing paper on which the document image is printed. As another technology, an invention is disclosed wherein the document image is reduced, the marginal regions are expanded, and advertisement images are printed in those marginal regions.

As still another technology, an invention is disclosed wherein the document image is printed on the printing paper superimposed with the advertisement image printed more lightly than the document image. And, further, an invention is disclosed wherein the size of the advertisement image is adjusted to match the size of the marginal region, where there is a difference in size between the printing paper and the document image, and the document image and advertisement image are printed on the same sheet of printing paper.

However, none of these technologies make note of how an advertisement image might be printed on the same sheet of printing paper in the case of the combined printing of the document image on the printing paper.

It is an object of the present invention to provide an image forming device for printing advertisement images on a sheet of printing paper without reducing the visibility of the document images which are printed in combination on the printing paper.

### SUMMARY OF THE INVENTION

The image forming device according to the present invention, for combining and printing multiple document images on a single sheet of printing paper, comprises capturing means for reading the document and capturing document images; storing means for storing advertisement images to be printed in addition to the document images; combining means for reducing each document image, laying out the reduced document images, and generating a combined image so as to include multiple document images captured by the capturing means on a single sheet of printing paper; composing means for extracting the marginal regions demarcating adjacent document images in the combined image and composing the combined image with the advertisement image so that the advertisement images form the borderlines between the adjacent document images in the extracted marginal regions; and printing means for printing the image composed by the composing means on printing paper.

In this constitution, it is preferable that the advertisement images be band-shaped images; and that the composing means compose the combined image and the advertisement image so that the lengthwise direction of the advertisement image is parallel to the lengthwise direction of the extracted marginal region, and the width of the advertisement image perpendicular to the length thereof be less than the width of the marginal region.

Also, in this constitution, it is preferable that setting means be further provided for setting whether to print the advertisement image on the printing paper based on a user's operation commands; and that the composing means compose the advertisement image into the combined image when the setting is made with the setting means to print the advertisement image on the printing paper.

Also, in this constitution, it is preferable that the advertisement image comprise a band-shaped background image and advertisement text including at least text or markings displayed on the background image.

The invention recited in the first claim makes possible the following: a plurality of document images are reduced so as to be included on a single sheet of printing paper, a combined image is generated, marginal regions demarcating adjacent document images are extracted from the combined image, advertisement images are printed on the printing paper without reducing the visibility of the combined and printed document images, because advertisement images are printed as borderlines of document images. The marginal regions demarcating document images are generally located in areas where the user's eyes will tend to stop, such as in the central portion of the printing paper, or the like; because of being printed in such marginal regions, the advertisement images can be made more attention-getting for the user.

The invention recited in the second claim makes possible the following: the advertisement image is printed on the printing paper without reducing the visibility of the combined and printed document images, because an advertisement image is composed so that the lengthwise direction of the advertisement image is parallel to the lengthwise direction of the marginal region demarcating the document images in the combined image, and the width of the band-shaped advertisement image perpendicular to the length thereof is less than the width of the marginal region.

The invention recited in the third claim makes possible the following: the user selects whether to have printing of advertisement images.

The invention recited in the fourth claim makes possible the following: the advertisement line is printed more closely to the borderline, so that the advertisement image can be printed on the printing paper without creating an unnatural sensation, because the advertisement text is on a band-shaped background image.

### BRIEF DESCRIPTION OF THE DRAWINGS

FIG. 1 is a schematic side view showing mainly the mechanical constitution of the image forming device according to the present invention as applied to a copier.

FIG. 2 is a block diagram of the functional constitution of the copier shown in FIG. 1.

FIG. 3 is a flow chart showing the operations when this copier prints advertisement images on printing paper.

FIG. 4 is a drawing showing an example of the operations screen displayed on a display unit when the user selects the combined printing mode.

FIG. 5A and FIG. 5B are drawings showing an example of an output image generated with the printing control unit; FIG. 5A shows an overview of the output image; FIG. 5B shows a detail of the advertisement image included in the output image.

### DETAILED DESCRIPTION OF THE PREFERRED EMBODIMENTS

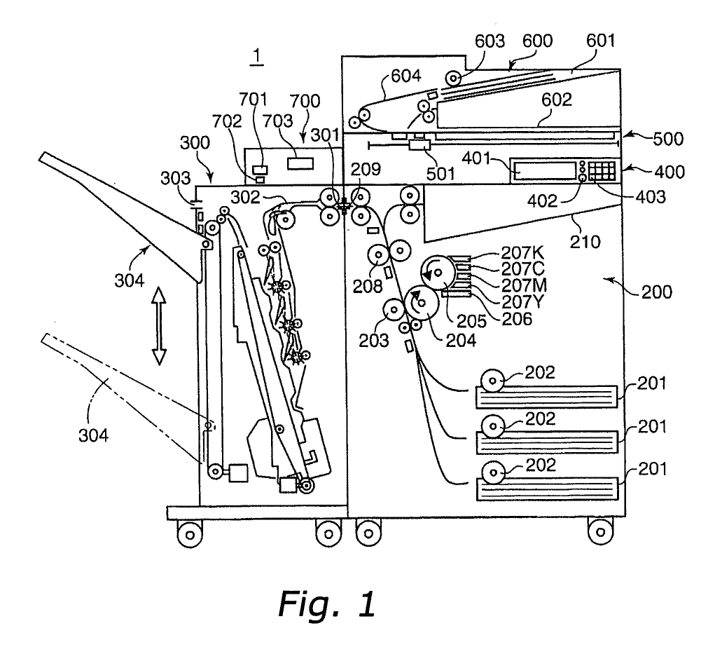

Preferred embodiments of the present invention are described below with reference to the drawings. FIG. 1 is a side view schematic showing mainly the mechanical constitution when the image forming device relating to the present invention is applied to a copier. Note that, this copier is disposed in a shop providing users with copying services such as a convenience store, stationery goods shop, or the like. This copier comprises a main unit 200, a paper after-processing unit 300 disposed on the left side of the main unit 200, an operation unit 400 for the user to input various operation commands and the like, a document reading unit 500 disposed in the upper portion of the main unit 200, a document feeding unit 600 disposed above the document reading unit 500, and a fee collecting device 700 for the user to pay copying fees.

The operation unit 400 comprises an operation panel 401, a start key 402, a numeric key pad 403, and the like. The operation panel 401 displays various operations screens, along with various operations buttons for the user to input various operation commands. The start key 402 is used for the user to input the print execution command and the like; the numeric key pad 403 is used for inputting the number of prints and the like.

The document feeding unit 600 comprises a document loading unit 601, a document output unit 602, a feed roller 603, a document transport unit 604, and the like; the document reading unit 500 comprises a scanner 501 and the like. The feed roller 603 feeds a document set in the document loading unit 601; the document transport unit 604 transports the fed document one sheet at a time over the scanner 501. The scanner 501 successively reads the transported document; and the read document is output to the document output unit 602.

The main unit 2001 comprises a plurality of paper supply cassettes 201, a plurality of feed rollers 202, a transfer roller 203, an intermediate transfer roller 204, a photosensitive drum 205, an exposure device 206, development devices 207Y, 207M, 207C, 207K for each color (yellow, magenta, cyan, and black), a fixing roller 208, an outlet 209, an output tray 210, and the like.

The photosensitive drum 205 is uniformly charged by a charging device (not shown) while the photosensitive drum rotates in the direction indicated by the arrow. The exposure device 206 converts a modulated signal, generated based on the document image data read by the document reading unit 500, to a laser beam, outputs the laser beam, and forms an electrostatic latent image in each color on the photosensitive drum 205. The development devices 207Y, 207M, 207C, 207K supply developer in each color to the photosensitive drum 205 and form toner images in each color.

With the intermediate transfer roller 204, the toner images in each color are transferred from the photosensitive drum 205 and a color toner image is formed on the intermediate transfer roller 204.

Meanwhile, the feed roller 202 pulls the printing paper from the paper supply cassette 201 containing printing paper and feeds the printing paper to the transfer roller 203. The transfer roller 203 transfers the toner image on the intermediate transfer roller 204 to the transported printing paper; and the fixing roller 208 heats and fixes the transferred toner image to the printing paper. Thereafter, the printing paper is transported from the outlet 209 of the main unit 200 to the paper after-processing unit 300. Also, the printing paper is output as necessary to the output tray 210.

The paper after-processing unit 300 comprises an infeed opening 301, a printing paper transport unit 302, a outfeed opening 303, a stacking tray 304, and the like. The printing paper transport unit 302 successively transports the printing paper transported from the outlet 209 to the infeed opening 301, and finally outputs the printing paper from the outfeed opening 303 to the stacking tray 304. The stacking tray 304 is constituted to move upwards and downwards, in the direction indicated by the arrow, according to the cumulative number of sheets of printing paper outputd from the outfeed opening 303.

The fee collecting device 700 comprises a bill slot 701 into which a user inserts bills, a coin slot 702 into which a user inserts coins, a display unit 703 for displaying the inserted fee, and the like.

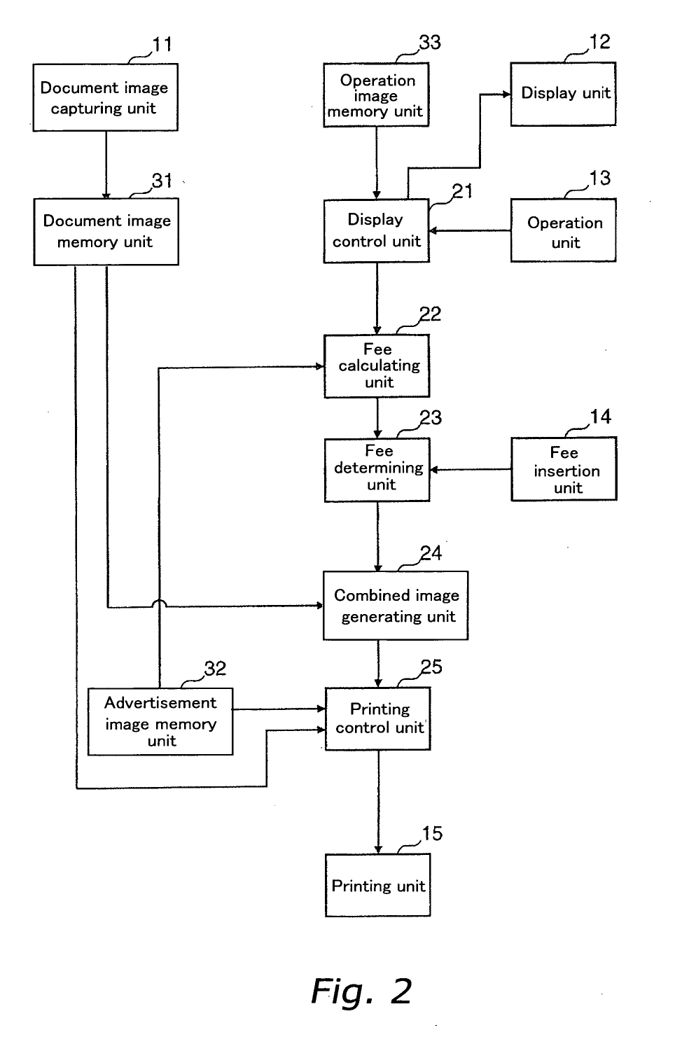

FIG. 2 is a block diagram showing the functional constitution of the copier shown in FIG. 1. This copier comprises a document image capturing unit 11, a display unit 12, an operation unit 13, a fee insertion unit 14, a printing unit 15, a display control unit 21, a fee calculating unit 22, a fee determining unit 23, a combined image generating unit 24, a printing control unit 25, a document image memory unit 31, an advertisement image memory unit 32, and an operation image memory unit 33. The display control unit 21 through the printing control unit 25 comprise CPUs and the like; the document image memory unit 31 through the operation image memory unit 33 comprise storage devices such as a hard disk, RAM, or the like.

The document image capturing unit 11 comprises the image reading unit 500 shown in FIG. 1, and captures the image of the document (hereinafter “document image”) by optically reading the document and stores the document image in the document image memory unit 31. The display unit 12 comprises the operation panel 401 shown in FIG. 1, and displays various images under the control of the display control unit 21. The operation unit 13 comprises the operation unit 400 shown in FIG. 1.

The fee insertion unit 14 comprises the fee collecting device 700 shown in FIG. 1, and distinguishes the type of coins and bills inserted by the user, and calculates the copying fee inserted by the user. The printing unit 15 comprises the transfer roller 203, intermediate transfer roller 204, photosensitive drum 205, exposure device 206, development devices 207Y, 207M, 207C, 207K, and the fixing roller 208 shown in FIG. 1; and the printing unit prints the output image generated by the printing control unit 25 on the printing paper.

The document image memory unit 31 stores the document image captured by the document image capturing unit 11. The advertisement image memory unit 32 stores the advertisement images, and the predetermined discount rates for the advertisement images. In this embodiment, an image whereon is written advertisement text comprising predetermined text, markings, or the like, on a narrow, band-shaped background image, is employed as an advertisement image. Moreover, the width of the background image in a direction perpendicular to the length is less than the width of the marginal regions demarcating the document images discussed below.

The operation image memory unit 33 stores various operation images displayed on the display unit 12 when the user inputs various operation commands to the copier.

The display control unit 21 causes various operation images stored in the operation image memory unit 33 to be displayed on the display unit 12. Also, the display control unit 21 causes various data input by the user via the operation unit 13 to be displayed on the display unit 12.

The fee calculating unit 22 reads the discount rate corresponding to the advertisement image from the advertisement image memory unit 32, and calculates the copying fee by multiplying the read discount rate by the predetermined copying fee per one sheet of printing paper for combined printing.

The fee determining unit 23 determines whether the copying fee paid into the fee insertion unit 14 by the user is in excess of the copying fee calculated by the fee calculating unit 22; and, if there is an overage, outputs a control signal to cause the combined image generating unit 24 to generate a combined image.

When a control signal is received from the fee determining unit 23, the combined image generating unit 24 sequentially reads from the document image memory unit 31 the number of document images corresponding to the type of combined printing, such as 2in 1, 4in 1, or the like, set by the user, reduces each document image so that the document images read will be printed on a single sheet of printing paper, lays out the reduced document images in predetermined rows and columns, and generates a one page combined image.

The printing control unit 25 extracts the marginal regions demarcating the document images forming the combined image from the combined image generated by the combined image generating unit 24, composes the combined image and advertisement image so that the advertisement image is displayed on the extracted marginal regions, and generates an output image.

In this embodiment, the document image capturing unit 11 is corresponds to an example of capturing means, the advertisement image memory unit 32 corresponds to an example of storing means, the combined image generating unit 24 corresponds to an example of combining means, the printing control unit 25 corresponds to an example of combining means, and the printing unit 15 corresponds to an example of printing means.

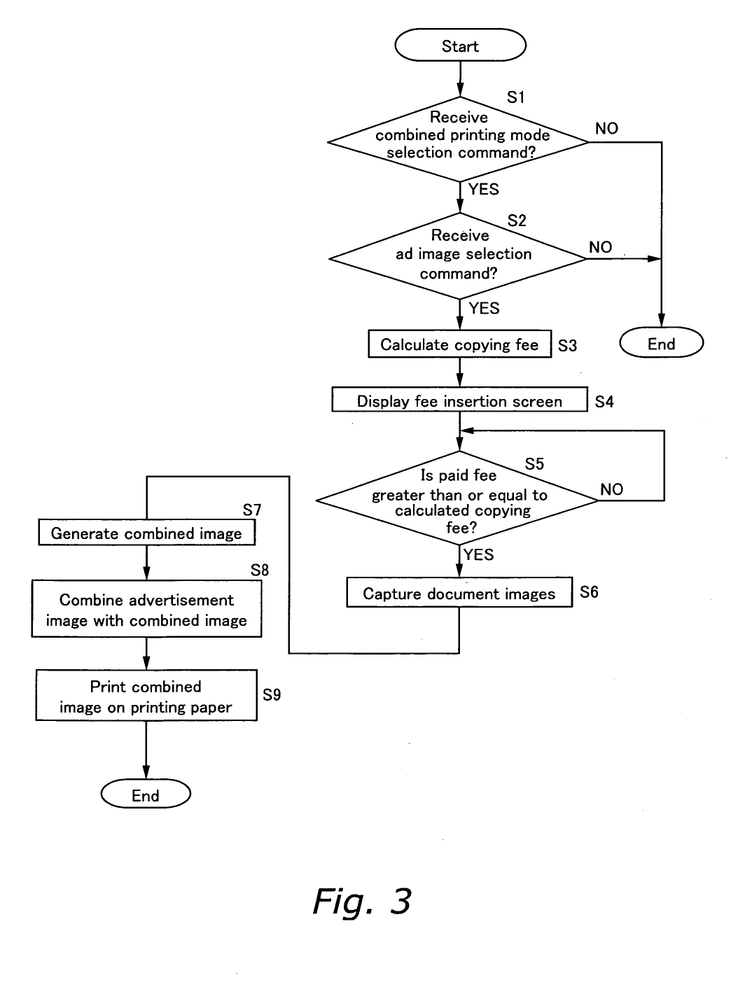

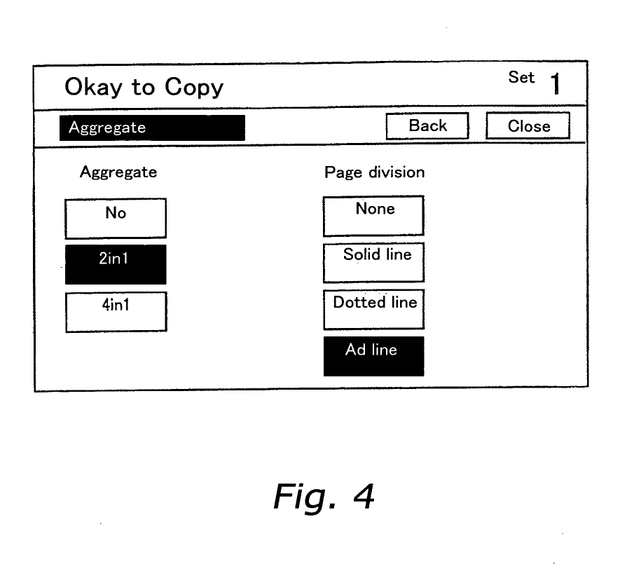

FIG. 3 is a flow chart showing the actions when this copier prints advertisement images on printing paper. Below, the operations of this copier printing advertisement images are described using the flow chart shown in FIG. 3. In step S1, when the operation unit 13 receives an operation command from the user to select the combined printing mode (YES in S1), the process advances to step S2; when the operation unit 13 receives an operation command from the user to not select the combined printing copy mode (NO in S1), the process terminates. FIG. 4 is a drawing showing an example of the operations screen displayed on the display unit 12 when the user selects the combined printing mode. On the operations screen in FIG. 4, three buttons, “No”, “2 in 1”, and “4 in 1”, are arranged in a vertical line below the location marked “Combine”. The user selects the combined printing mode by pressing the “2 in 1 ” or “4 in 1 ” button on the operations screen shown in FIG. 4.

When the “2 in 1” button is pressed, this copier executes the combined printing to print two document images on a single sheet of printing paper; when the “4 in 1” button is pressed, this copier executes the combined printing to print four document images on a single sheet of printing paper. On the other hand, when the “No” button is pressed, the combined printing mode is not selected for this copier and the process in the flow chart shown in FIG. 3 terminates.

In step S2, when the operation unit 13 receives the operation command from the user to print advertisement images (Yes in S2), the process advances to step S3; when the operation unit 13 receives the selection command from the user not to print advertisement images (No in S2), the process terminates.

Here, the user selects whether to print advertisement images on the printing paper by pressing the “none”, “solid line”, “dotted line” or “advertisement line” buttons displayed below the “page division” location on the right side of the operations screen shown in FIG. 4.

When the “none”, “solid line”, or “dotted line” button is pressed, this copier does not execute the process to print advertisement images on the printing paper, but it does execute the process to print advertisement images on the printing paper when the “advertisement line” button is pressed.

In step S3, the fee calculating unit 22 calculates the copying fee by multiplying the copying fee per page of printing paper in combined printing, with a predetermined discount rate corresponding to the advertisement images stored in the advertisement image memory unit 32.

In Step S4, the display control unit 21 causes the display unit 12 to display an image to inform the user of the calculated copying fee.

In Step S5, the fee determining unit 23 compares the copying fee paid by the user with the fee insertion unit 14 to the copying fees calculated by the fee calculating unit 22; when the paid copying fee is greater than or equal to the calculated copying fee (Yes in S5), the process advances to step S6; and when the paid copying fee is less than the calculated copying fee (No in S5), the process returns to step S5.

In step S6, the document image capturing unit 11 reads the document placed in the document loading unit 601 and stores the document to the document image memory unit 31. The document image capturing unit 11 reads two document pages in succession when the user has pressed the “2 in 1” button, and reads four document pages in succession when the “4 in 1” button was pressed.

In step S7, the combined image generating unit 24 successively reads and reduces the multiple document images to be combined and printed on a single sheet of printing paper, from among the document images stored in the document image memory unit 31, and lays out predetermined columns and rows and generates the combined image. When the user has not indicated the size of printing paper for the output, the combined image generating unit 24 reduces each of the document images so that the multiple document images read will fit on printing paper of the same size as the document read by the document image capturing unit 11. On the other hand, when the user has indicated the size of printing paper for the output, each of the document images are reduced so that the multiple document images read from the document image memory unit 31 will fit on printing paper of the indicated size.

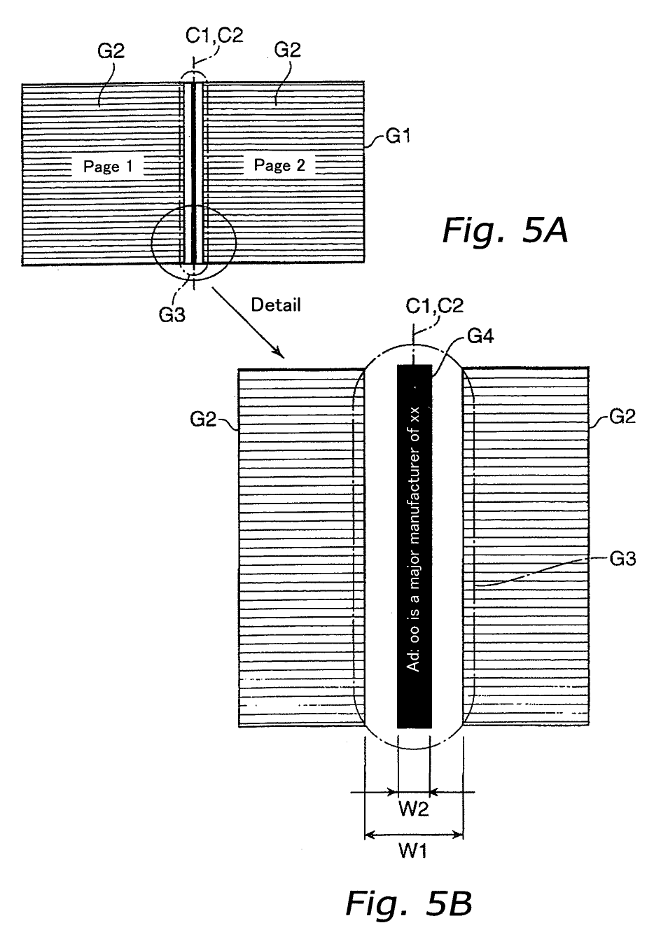

In step S8, the printing control unit 25 extracts the marginal regions demarcating the document images from the combined image, composes the advertisement image into the extracted marginal regions, and generates an output image. FIG. 5A and FIG. 5B are drawings showing an example of an output image generated by the printing control unit 25; (a) shows an overview of the output image; and FIG. 5B shows a detail of the advertisement image included in the output image.

As shown in FIG. 5A, the printing control unit 25 extracts the marginal region G3 demarcating the document images G2 from the combined image GI. The combined image GI and advertisement image G4 are composed so that the center line C2 of the advertisement image G4 overlays the center line C1 of the marginal region G3. The center line C1 passes through the center of the width W1 of the marginal regions G3 and expresses a line parallel to the length of the marginal region G3; the center line C2 passes through the center of the width W2 of the advertisement image G4 and expresses a line parallel to the length of the marginal region G3. Furthermore, the marginal region G3 is strip shaped (band shaped); when the document images are combined and printed in two rows and two columns (4in 1), there are two marginal regions G3 demarcating the document images.

Then, as shown in FIG. 5B, the band-shaped image lengthwise with respect to the length of the marginal region G3 is the background in the marginal region G3; and the advertisement image G4, in which is printed the predetermined advertisement text (“OO is a major manufacturer of XX” in the example in FIG. 5B), is combined on that background.

In step S9, the printing unit 15 prints the output image generated by the printing control unit 25 on the printing paper.

As described above, advertisement images can be printed with this copier, without reducing the visibility of the document images which are combined and printed. The advertisement images are printed in the marginal regions for demarcating the document images; these marginal regions are located at positions where the user's eye will tend to fall, such as the center of the printing paper, thereby making the advertisements highly effective.

In the embodiment described above, 4 in 1 or 2 in 1 were selected for combined printing modes, but the combined printing modes are not limited to these and the present invention may also be applied in the case of combined printing six or more document pages on a single sheet of printing paper. Also, in the case of combined printing four or more document sheets on a single sheet of printing paper such as in 4 in 1 or the like, there are multiple marginal regions for demarcating the document images; in this case, the same advertisement image may be printed in all or some of the marginal regions, or different types of advertisement images may be printed in all or some of the marginal regions. In the case of printing multiple advertisement images, the discount rate for the copying fee may be increased.

Furthermore, when there are multiple marginal regions for demarcating the document images, the background image of the advertisement image may be given the form of the marginal regions (for example, the form of a cross in the case of 4 in 1 with document images arranged in two columns and two rows).

What is claimed is:

1. An image forming device for combining and printing multiple document images on a single sheet of printing paper, comprising:
capturing means for reading a document and capturing document images,
storing means for storing advertisement images to be printed in addition to the document images,
combining means for reducing each document image, laying out the reduced document images, and generating a combined image, so as to include multiple document images captured by the capturing means on a single sheet of printing paper,
composing means for extracting the marginal regions demarcating adjacent document images in the combined image and composing the combined image with the advertisement image so that the advertisement images form borderlines between adjacent document images in the extracted marginal regions, and
printing means for printing an image combined by the combining means on printing paper.

2. The image forming device recited in claim 1 wherein the advertisement image is a band-shaped image; and
the composing means compose the combined image with the advertisement image so that the lengthwise direction of the advertisement image is parallel to the lengthwise direction of the extracted marginal region, and the width of the advertisement image perpendicular to the length thereof is less than the width of the marginal region.

3. The image forming device recited in claim 1 further comprising setting means for setting whether to print the advertisement image on printing paper based on a user's operation commands; and wherein
the composing means compose the advertisement image into the combined image when a setting is made with the setting means to print the advertisement image on the printing paper.

4. The image forming device recited in claim 1 wherein the advertisement image comprises a band-shaped background image and advertisement text including at least text or markings displayed on a background image.
